(19) United States
(12) Patent Application Publication
(10) Pub. No.: US 2004/0049595 A1
(43) Pub. Date: Mar. 11, 2004

(54) System for proactive management of network routing

(76) Inventors: Mingzhou Sun, Troy, NY (US); Kenneth Vastola, Troy, NY (US)

Correspondence Address: Jon D. Grossman, Dickstein Shapiro Morin & Oshinsky, 2101 L Street NW, Washington, DC, 20037-1526, US

(21) Appl. No.: 10/433,322

(22) PCT Filed: Dec. 4, 2001
(86) PCT No.: PCT/US01/45160

(51) Int. Cl. G06F 15/173

(52) U.S. Cl. 709/238

(57) ABSTRACT

The invention provides a system and method for managing network routing utilizing mathematical analysis. The method includes the act of copying a current setting of link costs to a new setting and utilizing the new setting of link cost to compute the shortest path routes used for all source and destination pairs. For each of the source destination pair, corresponding traffic volume is cast to each link along the route. In case of multiple routes with equal routes, traffic is split among the routes. Next, the traffic caused by all source and destination pairs is summed up to get the utilization of each link. Then, the value of objective function of utilization and link cost is computed. If a minimum is determined, the new setting of link cost is installed. If not, the utilization of each link is mapped into a new link cost and the shortest path routes are computed over.

The United States Government has certain rights in this invention pursuant to the Defense Advanced Research Projects Agency (DARPA) Contract Number F30602-00-2-0537 between the Department of Defense and Rensselaer Polytechnic Institute.

### BACKGROUND OF THE INVENTION

1. Field of the Invention

The present invention relates to traffic engineering and, more particularly, to a system and method for network routing utilizing coordinated adaptive link cost management.

2. Description of Prior Art:

Traffic engineering is defined as the task of mapping traffic flows onto an existing physical topology. By evenly balancing the traffic across the network, congestion caused by uneven distribution of traffic can be avoided. Traffic engineering is becoming essential for internet service providers (ISPs) due to an ever-increasing need to provide a good quality of service to customers and to sustain large growth in traffic.

Several approaches have been taken to solve the traffic engineering problem in the Internet. One such approach is to optimize the link weights of the existing network running, for example, Open Shortest Path First (OSPF) such that the OSPF routing with these link weights leads to desired routes. It is advantageous to utilize the existing routing protocol and architecture for ease of compatibility and reduced costs. But, the drawback with utilizing existing OSPF routing for traffic engineering is the shortest path nature of OSPF. OSPF routes traffic on shortest paths based on the advertised link weights. As a result, the link along the shortest path between the two nodes may become congested while the links on longer paths may remain idle. OSPP also allows for Equal Cost Multi Path (ECMP) where the traffic is distributed equally among various next hops of the equal cost paths between a source and a destination. This is useful in distributing the load to several shortest paths. However, the splitting of load by ECMP can be disadvantageous as well if the several shortest paths become congested. Also, increased communication and computation overhead, increased routing table size and potential routing instability are some of the drawbacks of constraint based routing such as OSPF.

Various methods have been proposed to balance the traffic across the network in an OSPP routing framework. In one approach, link weights are adapted to reflect the local traffic conditions on a link or to avoid congestion. This is called adaptive routing or traffic-sensitive routing. However, adapting link weights to traffic conditions leads to frequent route changes and is unstable. Further, prior art schemes were based on the local information and independent local decisions were made by the routers to change the link weights. But, routers generally do not have any knowledge of the traffic load on distant links and therefore cannot optimize traffic allocation.

Hence, what is needed is a system and method for managing network routing which can optimize traffic. In particular, what is needed is a system and method for proactive management of network routing which reduces oscillation and is capable of utilizing existing routing protocols or architecture.

### SUMMARY OF THE INVENTION

In an exemplary embodiment of the present invention, a method of managing network routing utilizing mathematical analysis is provided. The method includes the act of copying a current setting of link costs to a new setting and utilizing the new setting of link cost to compute the shortest path routes used for all source and destination pairs. For each of the source destination pairs, corresponding traffic information is cast to each link along the route. In case of multiple routes with equal routes, traffic is split among the routes. Next, the traffic caused by all the source and destination pairs is summed up to get the utilization of each link. Then, the value of the objective function of utilization and the link cost is computed to determine the penalty. If a minimum penalty is determined, the new setting of link cost is installed. If not, the utilization of each link is mapped into a new link cost and the shortest path routes are computed over.

In another object of the present invention, a system for network routing management is provided comprising a network comprising hosts connected by a domain. The domain further comprises routers and links for carrying data to and from the host and a device for collecting traffic information from the domain for analysis by a management station. The station is programmed to copy a current setting of link costs to a new setting of link costs for a source and destination pair and compute a shortest path route for the pair. Further, the station is programmed to cast a corresponding traffic information to each link along the route and compute a utilization of each link by summing up the traffic caused by the pairs. The station is also programmed to calculate a penalty by computing a value of objective function of the utilization and the new link cost and install the new link cost if a minimum penalty is determined.

The foregoing and other advantages and features of the invention will become more apparent from the detailed description of preferred embodiments of the invention given below with reference to the accompanying drawings.

### BRIEF DESCRIPTION OF THE DRAWINGS

FIG. 1 depicts an information architecture of the present invention;

FIG. 2 depicts an algorithm of the metric management (metricman) of the present invention;

FIG. 3 depicts a NSPNET backbone topology for the simulation setup;

FIG. 4 depicts a link utilization performance of metricman;

FIG. 5 depicts a packet loss percentage per link performance of metricman;

FIG. 6 depicts a average UDP Packet Delay performance of metricman;

FIG. 7 depicts a TCP round trip time (RTT) performance of metricman;

FIG. 8 depicts a TCP retransmission of metricman;

FIG. 9 depicts a total packet loss comparison of metricman and HNcost;

FIG. 10 depicts a end-to-end delay comparison of metricman and HNcost;

FIG. 11 depicts link cost changes with HNcost, with average end-to-end traffic at 2300 Bps;

FIG. 12 depicts an exemplary topology utilized in the invention;

FIG. 13 depicts another exemplary topology utilized in the invention;

FIG. 14 depicts a link utilization of metricman with the topology of FIG. 12;

FIG. 15 depicts a depicts a link utilization of metricman with the topology of FIG. 13;

FIG. 16 depicts metricman with different traffic level;

FIG. 17 depicts metricman with different traffic locality; and

FIG. 18 depicts metricman with all persistent TCP traffic.

### DETAILED DESCRIPTION OF PREFERRED EMBODIMENTS

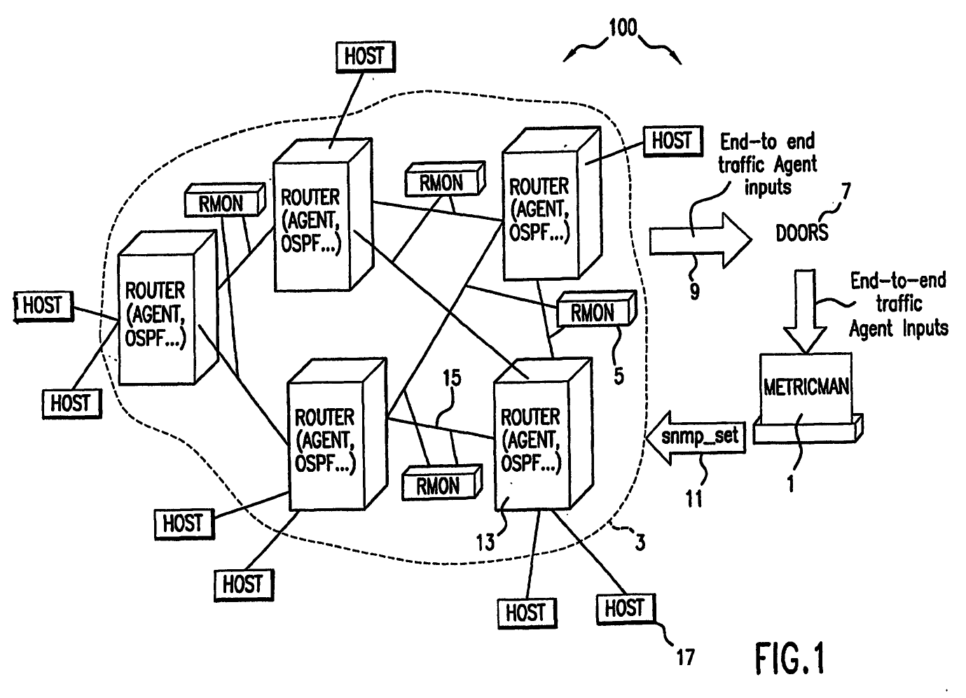

The present invention will be described in connection with exemplary embodiments illustrated in FIGS. 1-18. Other embodiments may be realized and other changes may be made to the disclosed embodiments without departing from the spirit or scope of the present invention.

Architecture

In the context of the overall architecture, the routing management component could operate as an independent tool or it may interact with the intelligent agent. It might incorporate the probability of network anomaly from the intelligent agent into its link metrics or it could use a high value of this probability as a trigger to activate an algorithm to search for the optimal setting of link costs based upon the new network dynamics.

Routing Management in Proactive Network Management Framework

Both distributed and centralized versions of this adaptive network metric technique were designed, implemented and evaluated. In the distributed algorithm, each router monitors its out-going links and determines, based on local information about the utilization of its own links, the corresponding link costs it will use and advertise to other routers. The mapping from the link utilization to link cost is a non-decreasing function reflecting that a more heavily loaded link is less desirable compared to a less loaded one. To dampen routing oscillation and ensure convergence, a number of techniques are employed. These include exponentially averaging and threshholding the utilization, quantizing, threshholding and upper bounding the link costs, and regulating link cost change periods. The propagation of the new link costs and route calculation is done by any suitable routing protocol. For example, HNcost was implemented and evaluated in simulation. The design and experimental results of HNcost are discussed below.

Referring now to FIG. 1, the centralized algorithm fits in a network management architecture 100 where there is a management station 1 (denoted as “Metricman,” discussed below) for the entire routing domain 3 if the domain is small enough and has a flat topology or one management station 1 for each routing area if the network is hierarchical. The network 100 is further provided with hosts 17 intended for running application programs. The domain 3 connects the hosts 17 to each other. Remote Network Monitoring (RMON) devices 5 collect (samples of) source-to-destination traffic information 9 between routers 13 which are connected by links 15. Then, the devices 5, either directly or through the Distributed Object Oriented Requirements System 7 (DOORS), report the information to the management stations 1. Each management station 1 performs a search of the optimal setting of link costs for all the links in its domain 3 when the need arises. If any of the link costs is changed, the management station 1 installs the new link costs by setting the corresponding Management Information Base (MIB) variables using Simple Network Management Protocol 11 (SNMP). Metric management (“Metricman”) is an example of such protocol utilized in management station 1 and has been evaluated in simulation. The design and experimental results of Metricman are discussed below.

Design

Routing management techniques were studied in simulation experiments using the UCB/LBNL/VINT Network Simulator, version 2, ns-2¹. HNcost is the ns-2 implementation of the distributed adaptive metric algorithm. When activated, HNcost in a node monitors the utilization and queue length of its out-going links and keeps the exponential averages of these quantities. HNcost periodically checks the average utilization and queue length against thresholds to decide if calculation of new link costs are necessary. If so, the HNcost checks if the minimum link cost change interval threshold is crossed. If the new link costs are not necessary, HNcost again periodically checks the average utilization and queue length against the thresholds. ¹http://www-mash.cs.berkeley.edu/ns/.

If the threshold is crossed above, it calculates the target new link costs based on the configured mapping function and regulates the target new link costs by a set of rules, such as maximum cost change, minimum cost change, change step size, to obtain the final new link cost. Then, it installs the new link cost and notifies the routing mechanism of the changes. If the threshold is not crossed, HNcost again periodically checks the average utilization and queue length against thresholds.

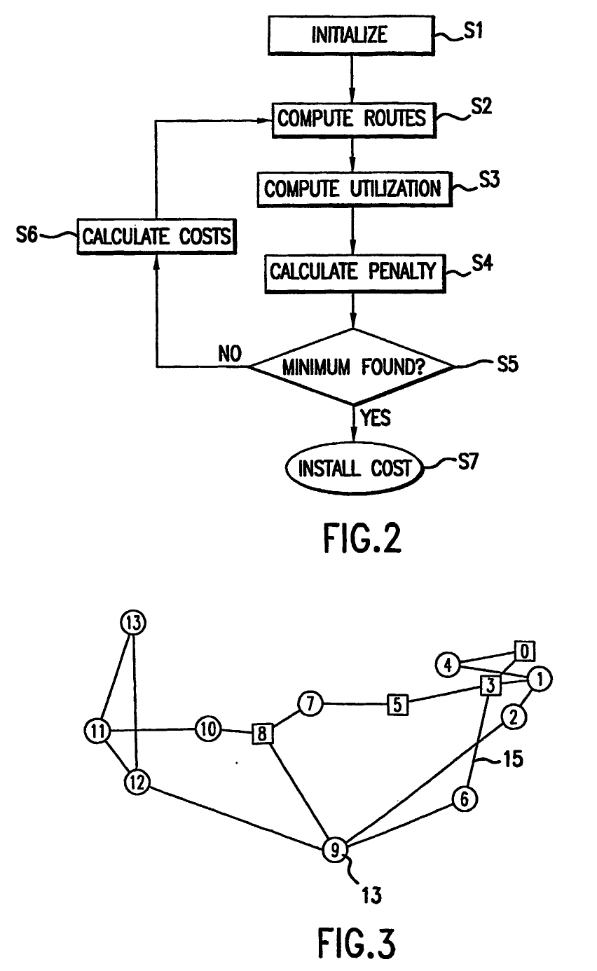

Referring now to FIG. 2, the basic operation of Metricman is illustrated. Metricman is the ns-2 implementation of the centralized metric algorithm. The process initializes at step S1. This step includes acquiring the current topology and gathering source to destination traffic information for all sources and destinations. Then, when activated, the current setting of link costs is copied to the “new” setting of link cost. Next, in step S2, the new setting of link cost is utilized to compute the shortest path routes used for all source and destination pairs 13. Next, in step S3, for each of the source destination pair 13, the corresponding traffic information is cast to each link along the route. In case of multiple routes with equal routes, traffic is split among the routes. Then, the traffic caused by all source and destination pairs is summed up to get the utilization of each link. Then, at step S4, the penalty is calculated by computing the value of the objective function of utilization and link cost. If a minimum penalty is determined at step S5, the process proceeds to step S7 where the new setting of link cost is installed and the ns-2 dynamic interface call back function is called to notify the changes. If a minimum penalty is not determined at step S5, the process proceeds to step S6, where the utilization of each link is mapped into a new link cost. Then, the process repeats steps S2 to S5 until a minimum is determined at step s5.

The existing dynamic routing protocol in the network will then calculate the routing table and propagate the changes of link costs throughout the network. In the invention, a dynamic routing protocol called rtProtoLS was developed and implemented in ns-2. In terms of the action it performs, rtProtoLS is designed to be a simplified OSPF-like protocol, and therefore, similarly to OSPF. For instance, each node sends out link state advertisement (LSA) to its peers when its link-state changes or every 30 minutes on average by default; each peer acknowledges the LSA, relays the new ones to its own peers except the ones that relayed the same LSA to it before; all nodes' LSAs are flooded through the network initially to form the topology database in all the nodes, which apply the Shortest Path First algorithm to calculate the next hop(s) to all destinations in the network; in addition, when a link comes back up, the nodes at both ends of the link will exchange their topology database to see it there's anything new there. If so, it will regenerate the appropriate LSA and send it out to other neighbors; and finally, all unacknowledged LSA and Topology messages will be resent after a time-out. This timer will be canceled if the link to the peer goes down.

Development Environment Description

The simulation components were developed by extending ns-2 version 2.1b4. The components were developed on Solaris 2.6 running on Sun Ultra 10 computers, and on Linux RedHat 5.0 running on Intel Pentium processors. The program editors were emacs and xemacs. The compilers were g++ 2.8.0 and g++ 2.8.1. In addition, nam, perl5, tcl/tk 8.0 were used as visualization development and testing tools.

Testing and Performance Results

Routing Management Simulation Experiment Environment

Simulation experiments were run on non-hierarchical topologies for both HNcost and Metricman. The topologies were either randomly generated, or taken from real topologies such as the old NSFNET backbone and ARPANET topologies. These topologies typically have fifteen to fifty nodes, with average degrees of connectivity at about two. The simulated traffic types were mixtures of random traffic generators with UDP transport, and simulation model of application protocols, such as Telnet, FTP, using TCP as their transport mechanism.

The link state routing protocol used in the simulation to propagate and compute routes is rtProtoLS, which resembles OSPF in a flat topology with point-to-point links. It was developed specifically to support investigation of adaptive metric for this invention, but was also contributed to the ns-2 user community as the only link state routing protocol in ns-2.

Methods and Parameters Evaluated

Simulation experiments were conducted to identify the major factors that determine the effectiveness of the proposed routing management mechanism. The following factors were considered: characteristics of the network topologies. (e.g., size, speed, connectedness, symmetricness); end-to-end traffic patterns. (e.g. local vs. long distance pairs); the presence of TCP flow control; in addition, different settings of the configuration parameters of the Metricman and HNcost are evaluated to gain insight to the network's reaction to the control mechanisms.

Performance Measurements in Experiments

For each simulation run, the following aggregate measurements were taken every simulation sample interval, including, percentage of the packets dropped by the network, end-to-end delay averaged over the UDP packets, TCP retransmission rate and TCP round trip time estimates.

Summary of Results

The results from a case study is first discussed to illustrate the key observations, followed by general results from more simulation experiments.

Case Study

The topology used in the case study is modified from the old NSFNET backbone, with fourteen nodes 13 and nineteen links 15, as shown in FIG. 3. Link speeds were set at 56,000 bits per second. Propagation delays were set to approximate the actual propagation delay in the real topology. Random traffic was generated using a Pareto traffic model with UDP transport to simulate aggregate traffic. Average rates of traffic between any two nodes were set to be the same and at a level such that the average link utilization was about 40%. In addition, long distance Telnet sessions were placed between selected nodes 13 as probes that collected TCP performance statistics. The simulation was run for 2000 seconds, with Metricman activated at the 1000^{th} second. The link state routing protocol for ns-2, rtProtoLS, was used to propagate and compute routes at simulation startup and after Metricman recomputed new link costs.

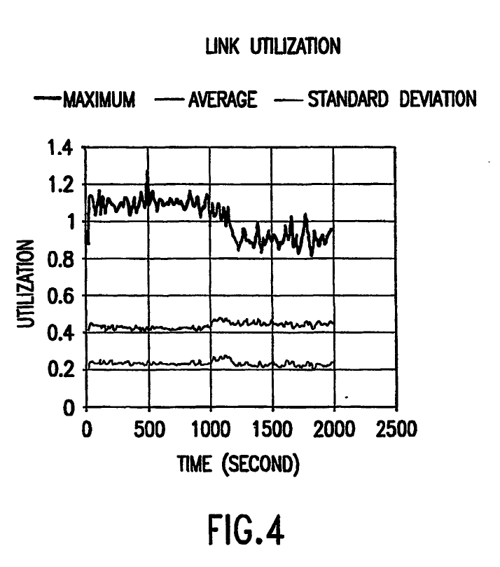

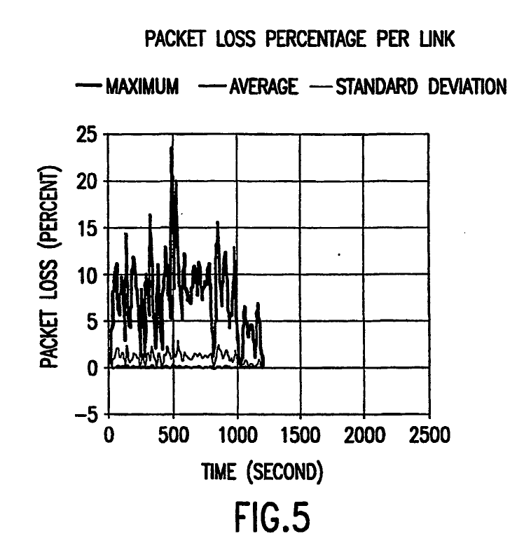

FIG. 4 shows the time series of the link utilizations. The statistics were collected every 15 seconds. The new link costs were computed by Metricman at the 1000^{th} second, the maximum link utilization dropped down from around 110% to around 90% shortly afterwards.

The average link utilization increased slightly for two reasons. First, fewer packets were dropped (which we will show in the next figure). This means that more packets stayed in the network. Second, some of the packets were routed away from the least hop count path, and thus traversed more hops than minimum. The standard deviation of the link utilization did not show significant change after Metricman was activated. Thus, Metricman balanced the network traffic by reducing the load on the most heavily loaded link. It also did this without inducing significant extra traffic on the network.

As a result of such traffic balancing, packet loss were greatly reduced. Before activation of Metricman, packet loss in the most loaded link was at around 10%. Shortly after activation of Metricman, packet loss was eliminated for the rest of the duration of the simulation, as shown in FIG. 5. This is because the traffic was set to be relatively stationary to better illustrate the long-term trend in the network. The temporary outburst of packets is queued in the link buffers with sizes of 50 packets and thus did not cause packet loss after the 1000^{th} second.

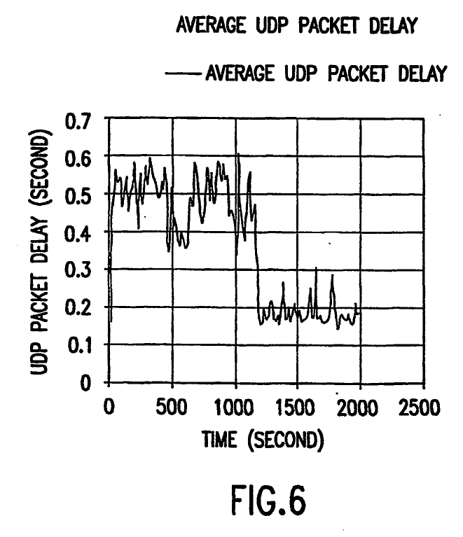

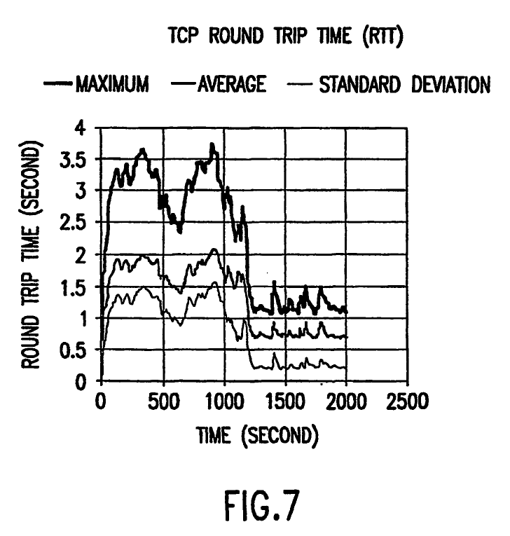

Reduced link utilization also translates into reduced queuing delay and therefore reduced end-to-end delay. This is demonstrated by the reduction of average UDP packet delay, shown in FIG. 6, as well as the reduction of estimated Round Trip Time (RTT), shown in FIG. 7, collected by TCP connections set up in the simulation as probes.

A number of observations can be drawn from the above case study. The overall network performance, in terms of packet drops and delays, is largely determined by the most loaded congested link or links. A small portion of packets traversing a few extra hops is more desirable than over-utilization of a few links in the network. When some packets are re-routed away from the most congested links, overall network performance is significantly improved in terms of packet drops and end-to-end delays.

Route Change on TCP Retransmission

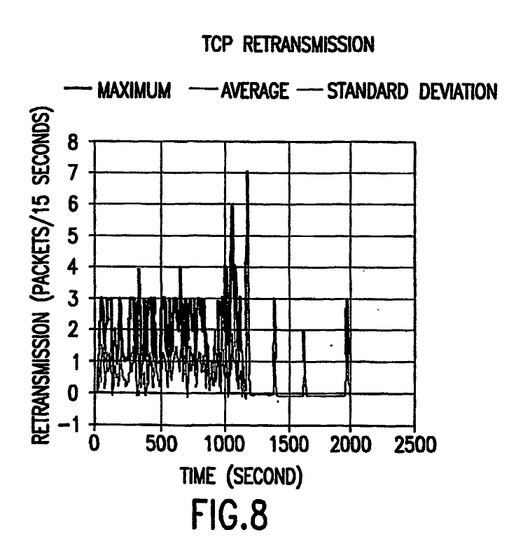

To examine the side effect of route changes on TCP connections, the time series of retransmission rate of Telnet/TCP connections from the same case study in FIG. 8 is studied.

From the graph, the TCP retransmission rate actually increased for the short time period immediately following the activation of Metricman. Due to changes that occurred throughout the network shortly after the 1000^{th} second, some of the packets that had been queued up in the buffers now traversed extra hops to get to their destinations and therefore caused out-of-order arrivals. This triggered retransmission in classic TCP without Selective Acknowledgment (SACK). In the long run, however, the retransmission is drastically reduced to sporadic occurrences due to time-outs of the delayed packets.

Comparing Metricman and Hncost

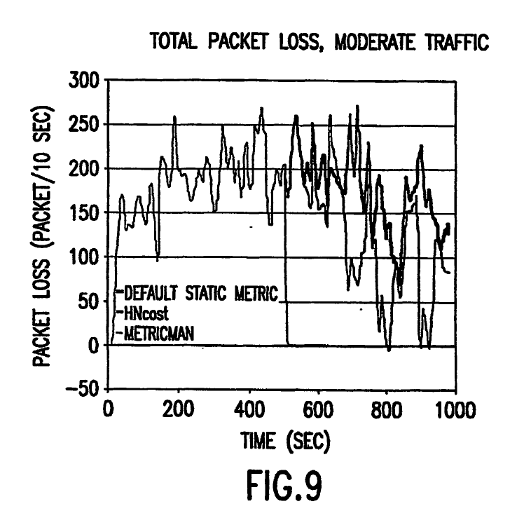

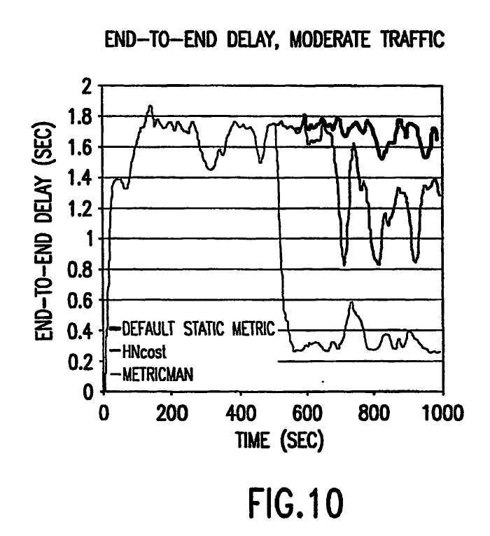

Simulations with similar settings were run to evaluate HNcost, the distributed computation of adaptive link costs. FIG. 9 and FIG. 10 show the time series of total packet losses and average end-to-end UDP delays, respectively, for three of the experiments. In the first experiment, the default link cost was used throughout the simulation for 1000 seconds. In the second, HNcost was active from the 500^{th} second till the end. In the third experiment, Metricman was activated once at 500^{th} second.

As seen from the figures, with HNcost, while packet loss and delay were reduced to some extent compared to the case with default costs, the network did not reach a steady state even after a considerable time period (500 seconds). This contrasts with the consistent and stable improvement of network performance when Metricman was used.

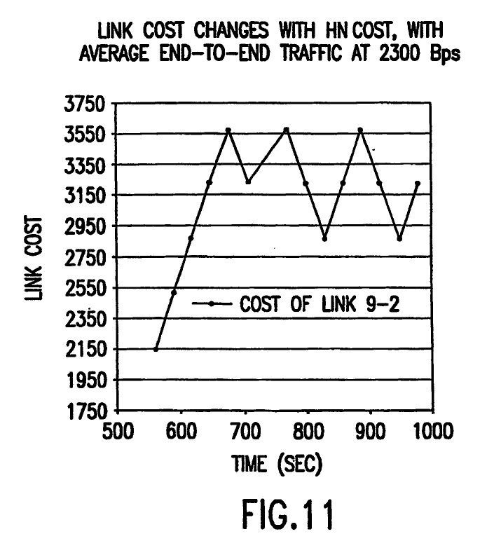

The reason for the poor performance of HNcost becomes apparent when the link cost evolution of one link is examined, link 9-2 from node 9 to node 2, as shown in FIG. 11. The link cost slowly increased to 3570 before oscillating around 3000 and did not reached steady state.

The HNcost instance in node 9 re-evaluated the cost for link 9-2 at every update interval (30 seconds), based on the weighted average of the link utilization over the past update intervals. HNcost instances in other nodes were doing the same thing for all other links in the network. When the link cost of a link was low, more traffic was routed to the link, which drove the link cost up. Once the link cost had become sufficiently high, some traffic was shed away from the link, which in turn drove the link cost back down. Without further stabilizing mechanism, the cost of the link oscillated between high and low with no guarantee to reach steady state.

TABLE 3.1
Link cost changes by Metricman for selected links.

| Link Id | Old cost | New cost |
|---|---|---|
| 2-9 | 1750 | 3570 |
| 12-9 | 1750 | 3570 |
| 9-2 | 1750 | 3570 |
| 9-12 | 1750 | 3570 |

The primary limitation of the distributed computation approach in HNcost is that each instance of HNcost has only local information and thus needs to wait for feedback from the network to determine the next step of action. Metricman, on the other hand, has the global information of traffic flows and performs the link cost iteration internally. In Table 3.1, for instance, Metricman changed the costs of the links between 2-9 and 9-12 from 1750 to be 3570 (other link costs not shown). It then installed the changed link cost in the network exactly once. This approach eliminates the possibility for link cost oscillation.

Other experimental results for Metricman are now discussed. To better understand the condition, under which routing management can be applied to improve network performance, and to confirm the observations we drew in the discussion above, more simulation experiments were conducted. Specifically, experiments were conducted to investigate the effectiveness of Metricman against different topologies, different traffic scenarios, the presence of flow control.

Metricman in Different Topologies

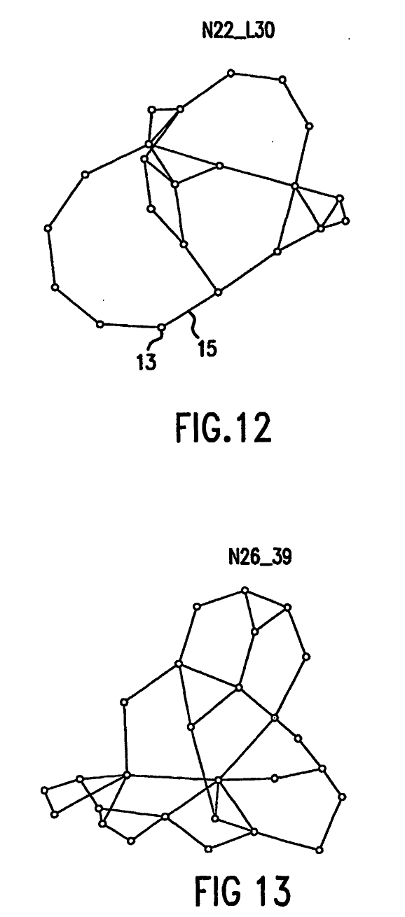

Random topologies were generated using GT-ITM, the Internet Topology Generator by Ellen Zegura at the Georgia Institute of Technology². Two of the random topologies are used to illustrate the example. The first one, N22_L30, shown in FIG. 12, has 22 nodes (13) and 30 links (15) with a link-to-node ratio of 1:36. The second one, N26_L39, shown in FIG. 13, has 26 nodes (13) and 39 links (15), with a link-to-node ratio of 1:5. ²http://www.cc.gatech.edu/fac/Ellen.Zegura/graphs.html.

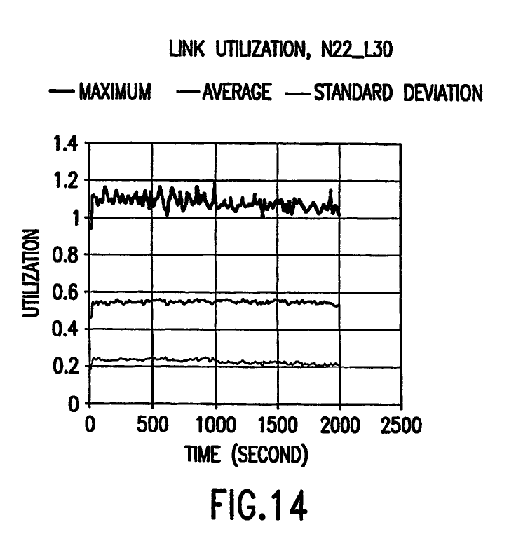

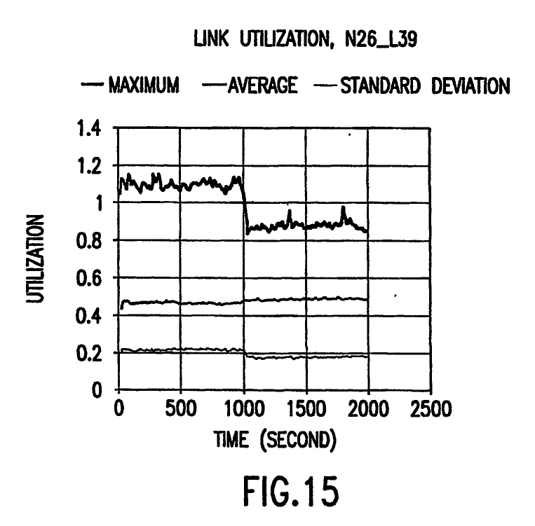

FIG. 14 and FIG. 15 show the time series of link utilization before and after the activation of Metricman at the 1000% second, for topology N22_{—}30 and N26_L39, respectively. The simulation setups in both cases were the same as in the case study discussed above, except for the placement of Telnet/TCP connections and absolute end-to-end traffic levels. The resulting link utilization, in terms of the average, maximum and standard deviation were similar in both cases before the activation of Metricman.

In the case of N22_L30, activation of Metricman did not have noticeable effects on link Utilization, whereas in the case of N26_L39, the maximum of the link utilization decreased from around 110% to around 90%. Although the link-to-node ratios, 1.36 for N22_L30 and 1.5 for N26_L39, for the two topologies are comparable, a more careful look at N22_L30 reveals an undesirable characteristic: there are two groups of nodes which are connected serially to form two long paths. This topology does not provide sufficient alternative routes to the most congested link under uniform end-to-end traffic level for all nodes. Compared to N22_L30, N26_L39 has a slightly higher link-to-node ratio and a more balanced layout of the links. In other words, N26_L39 is better connected than N22_L30 and thus leaves more choices for routing management.

Metricman Under Different Traffic Levels

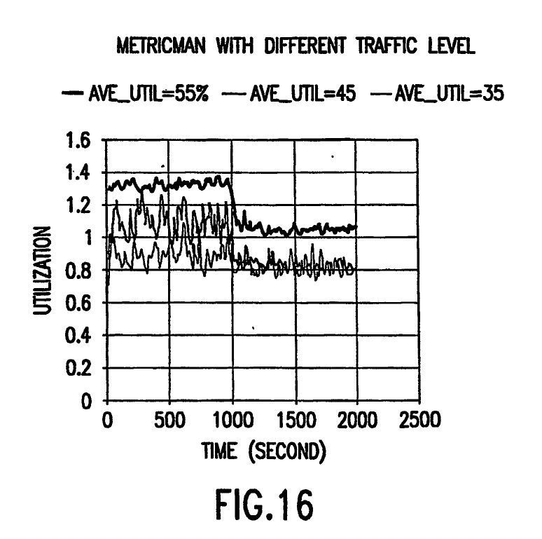

Simulation experiments were also conducted to evaluate the performance of Metricman under different traffic levels. In FIG. 16, the time series of the maximum link utilization for three traffic levels are shown. The topology is N26_L39 shown above. Other simulation settings were similar to the cases discussed above. The first series, ave_util=55%, represents an over-loaded network, with maximum link utilization at around 130% and average link utilization at 55% when using default link costs. The second one, ave_util=45%, represents a critically loaded network, with maximum link utilization just over 110% and average link utilization at. 45% when using default costs. The third one, ave_uti=35%, represents a heavily loaded network with maximum link utilization at around 90% and average link utilization at around 35% when using default link costs.

After activation of Metricman at the 1000^{th} second, it is seen from FIG. 16 that the maximum link utilizations in the over-loaded network dropped significantly from 130% to 105%. Even though the network is still over-loaded, the excessive packet arrival in the most congested link dropped from 30% to just over 5%. In the case of critically loaded network, maximum link utilization dropped from 110% to 85%, eliminating sustained excessive packet arrival. In the heavily loaded case, the maximum utilization also dropped from 90% to 80%. In other words, the network sees the most drastic improvement after the new routing when it was critically loaded. When the network is over loaded or just heavy load, Metricman can also reduce packet loss and delay significantly.

Metricman Under Different Traffic Locality Conditions

To study the effect of Metricman under different traffic locality conditions, simulations were set up to run under three types of end-to-end traffic conditions: mostly local, mostly long distance and uniform. In the mostly local traffic condition, the amount of traffic a node sends to its next-hop neighbor is about three times as much as the amount of traffic it sends to a neighbor 6 hops away. The opposite is true for mostly long distance traffic condition. In the uniform traffic condition, a node sends roughly equal among of traffic to all other nodes.

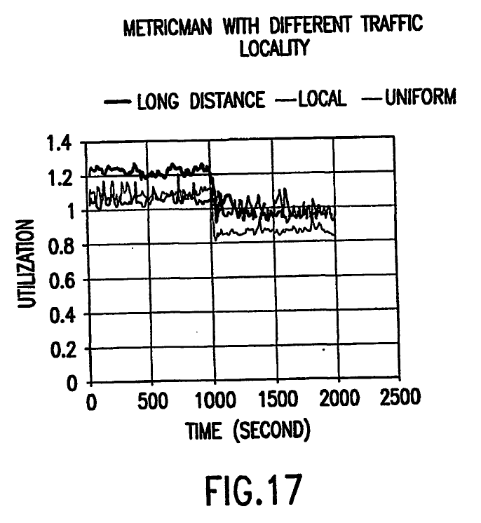

FIG. 17 shows the time series of the maximum link utilizations for three simulation runs under mostly long distance, mostly local and uniform traffic conditions as described above, on the N26_L39 topology with similar setup as other simulation cases. It is seen that Metricman significantly reduced the maximum link utilization under both uniform and mostly local traffic condition, but only reduced the maximum link utilization slightly (from about 105% to about 100%) in the case of mostly long distance traffic condition. Results from other simulations with different topology showed a similar trend.

Metricman and Long Lasting TCP Connections

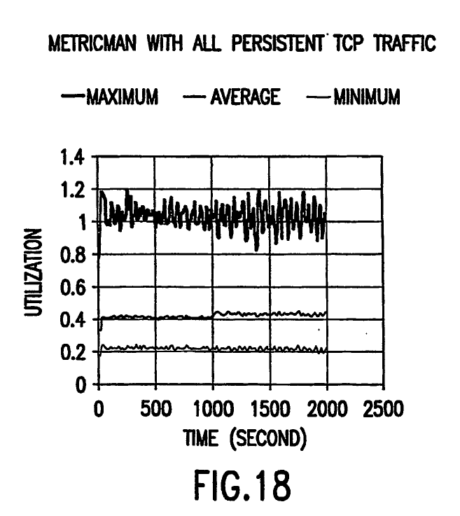

Simulations were also run with traffic consisting entirely of long lasting TCP connections, instead of the UDP connections as in other examples discussed above. FIG. 18 shows the time series of link utilization from one such simulation run in which the network was critically loaded. No significant changes were seen in the maximum, average or the standard deviation of the link utilization after the activation of Metricman at the 1000^{th} second. There were no significant changes in other performance indicators. Similar results were obtained from other simulation runs. This is because the long lasting TCP connections offer elastic traffic: traffic levels are mostly limited by the TCP transmission windows instead of by the amount of traffic generated by the pareto traffic model. In other words, if a link is not congested and therefore not dropping packets, TCP connections passing that link may keep sending more packets until the link starts dropping packets. Therefore, when the traffic models generated packets faster than TCP could send, the most congested links and their alternatives were all congested at similar levels. No alternative routing would have been able to change the situation significantly.

Metricman Parameter Recommended Range

Other simulations were run to establish guidelines for the parameters in the Metricman. Metricman was not very sensitive to small variations of the parameters as long as the parameters fall in the recommended ranges as listed in Table 3.2

TABLE 3.2
Metricman parameter recommended range.

| | | Recommended |
|---|---|---|
| Named | Meaning | range |
| Max_hop | Maximum link cost in terms of the | 2-4 |
| | default link cost | |
| Heavy_threshold | Threshold higher than which the | 0.7-0.9 |
| | load on the link is considered | |
| | heavy | |
| Step_size | Size of link cost change in terms of | 0.2-0.5 |
| | the default cost | |
| Change_threshold | Minimum difference between the | 0.5-1 |
| | target cost and the current cost | |
| | when a change is allowed | |
| Light_threshold | Threshold under which the load is | Less than 0.5 |
| | consider light | |

Summary of Results

The coordinated adaptive link cost management scheme, Metricman, combined with a link state routing protocol, can significantly improve network performance in terms of packet loss and end-to-end delay in well connected networks by balancing network loads, without introducing routing oscillation. HNcost, the distributed dynamic link cost algorithm, can reduce packet loss and end-to-end delay to some extend, but it can take a long time to convergence and can lead to routing oscillation. Route change can lead to temporary out-of-order packet arrival and causes more retransmission in TCP without selective acknowledgment shortly after the route change, but this short-term impact is compensated for by improved long-term performance of TCP in the form reduced round-trip time and retransmission rate. Critically loaded networks (in which the utilization of the most congested links is just over 100% using default routes) see the most drastic performance improvement after activation of Metricman. In the case with well-connected networks that are either overly loaded (utilization of the most congested links much higher than 100%) or heavily loaded (utilization of the most congested links close to 100%), Metricman can also significantly improve the overall network performance. In networks with long lasting TCP connections only, the most congested links are loaded at a similar level due to the fact that the TCP traffic levels are elastic and regulated by packet loss levels. Metricman was not effective in these special cases because there is no better alternative routing. Performance of Metricman is not very sensitive to small variations of the operational parameters as long as the parameters fall in the recommended range.

### CONCLUSIONS

Hence, the invention provides a method of managing network routing utilizing mathematical analysis. The method includes the act of copying a current setting of link costs to a “new” setting and utilizing the new setting of link cost to compute the shortest path routes used for all source and destination pairs. For each of the source destination pair, corresponding traffic information is cast to each link along the route. In case of multiple routes with equal routes, traffic is split among the routes. Next, the traffic caused by all source and destination pairs is summed up to get the utilization of each link. Then, the value of objective function of utilization and link cost is computed to calculate a penalty. If a minimum penalty is found, the new setting of link cost is installed. If not, the utilization of each link is mapped into a new link cost and the shortest path routes are computed over.

Also, the invention provides a system for network routing management is provided comprising a network comprising hosts connected by a domain. The domain further comprises routers and links for carrying data to and from the host and a device for collecting traffic information from the domain for analysis by a management station. The station is programmed to copy a current setting of link costs to a new setting of link costs for a source and destination pair and compute a shortest path route for the pair. Further, the station is programmed to cast a corresponding traffic information to each link along the route and compute a utilization of each link by summing up the traffic caused by the pairs. The station is also programmed to calculate a penalty by computing a value of objective function of the utilization and the new link cost and install the new link cost if a minimum penalty is found.

While the invention has been described in detail in connection with preferred embodiments known at the time, it should be readily understood that the invention is not limited to the disclosed embodiments. Rather, the invention can be modified to incorporate any number of variations, alterations, substitutions or equivalent arrangements not heretofore described, but which are commensurate with the spirit and scope of the invention. Accordingly, the invention is not limited by the foregoing description or drawings, but is only limited by the scope of the appended claims.

What is claimed as new and desired to be protected by Letters Patent of the United States is:

1. A method for internet routing management comprising the steps of:
copying a current setting of link costs to a new setting of link costs for a source and destination pair;
computing a shortest path route for said pair;
casting a corresponding traffic information to each link along said route;
computing a utilization of each said link by summing up said traffic information caused by said pair;
calculating a penalty by computing a value of objective function of said utilization and said new link cost; and
installing said new link cost if a minimum of said penalty is determined.

2. The method of claim 1, further comprising the act of calculating another setting of link cost if a minimum of said penalty is not determined.

3. The method of claim 2, further comprising the act of computing another shortest path route utilizing said another link cost.

4. The method of claim 1, wherein said act of casting further comprise the act of splitting traffic among said routes if there are multiple equal routes.

5. The method of claim 1, wherein said act of installing further comprise setting a corresponding Management Information Base variable utilizing Simple Network Management Protocol.

6. The method of claim 1, wherein said information is collected by Remote Network Monitoring devices.

7. A method for network routing management comprising the steps of:
computing a shortest path route for a source and destination pair utilizing a new link cost;
computing a utilization of each link along said route by summing up traffic information caused by said pair;
calculating a penalty by computing a value of objective function of said utilization and said new link cost; and
installing said new link cost if a minimum of said penalty is determined.

8. The method of claim 7, further comprising the act of calculating another link cost if a minimum of said penalty is not determined.

9. The method of claim 8, further comprising the act of computing another shortest path route utilizing said another link cost.

10. The method of claim 7, wherein said act of installing comprise setting a corresponding Management Information Base variable utilizing Simple Network Management Protocol.

11. The method of claim 7, wherein said information is collected by Remote Network Monitoring devices.

12. A method for network routing management comprising the steps of:
computing a utilization of each link along a shortest path route by summing up traffic information caused by a host pair;
calculating a penalty of said utilization and a new link cost of said route; and
installing said new link cost if a minimum of said penalty is determined.

13. The method of claim 12, further comprising the act of calculating another link cost if said minimum of said penalty is not determined.

14. The method of claim 13, further comprising the act of computing another shortest path route utilizing said another link cost.

15. The method of claim 12, wherein said act of installing further comprise setting a corresponding Management Information Base variable utilizing Simple Network Management Protocol.

16. The method of claim 12, wherein said information is collected by Remote Network Monitoring devices.

17. A system for network routing management comprising:
a network including at least one host connected by a domain, said domain further comprising routers and links for carrying data to and from said host and a device for collecting traffic information from said domain for analysis by a management station, said station being programmed to:
copy a current setting of link costs to a new setting of link costs for a source and destination pair;
compute a shortest path route for said pair;
cast a corresponding traffic information to each link along said route;
compute a utilization of each said link by summing up said traffic information caused by said pair;
calculate a penalty by computing a value of objective function of said utilization and said new link cost; and
install said new link cost if a minimum of said penalty is determined.

18. The system of claim 17, further comprising programming said station to calculate another setting of link cost if a minimum of said penalty is not determined.

19. The system of claim 18, further comprising programming said station to compute another shortest path route utilizing said another link cost.

20. The system of claim 17, wherein said programming to cast further comprise splitting traffic among said routes if there are multiple equal routes.

21. The system of claim 17, wherein said programming to install further comprise setting a corresponding Management Information Base variable utilizing Simple Network Management Protocol.

22. The system of claim 17, wherein said information is collected by Remote Network Monitoring devices.

23. A system for network routing management comprising:
a network including at least one host connected by a domain, said domain further comprising routers and links for carrying data to and from said host and a device for collecting traffic information from said domain for analysis by a management station, said station being programmed to:
compute a shortest path route for a source and destination pair utilizing a new link cost;
compute a utilization of each link along said route by summing up traffic information caused by said pair;
calculate a penalty by computing a value of objective function of said utilization and said new link cost; and
install said new link cost if a minimum of said penalty is determined.

24. The system of claim 23, further comprising programming said station to calculate another link cost if a minimum of said penalty is not determined.

25. The system of claim 24, further comprising programming said station to compute another shortest path route utilizing said another link cost.

26. The system of claim 23, wherein said programming to install further comprise programming to set a corresponding Management Information Base variable utilizing Simple Network Management Protocol.

27. The system of claim 23, wherein said information is collected by Remote Network Monitoring devices.

28. A system for managing network routing comprising:
a network including at least one host connected by a domain, said domain further comprising routers and links for carrying data to and from said host and a device for collecting traffic information from said domain for analysis by a management station, said station being programmed to:
compute a utilization of each link along a shortest path route by summing up traffic information caused by a host pair;
calculate a penalty of said utilization and a new link cost of said route; and
install said new link cost if a minimum of said penalty is determined.

29. The system of claim 28, further comprising programming said station to calculate another link cost if said minimum of said penalty is not determined.

30. The system of claim 29, further comprising programming said station to compute another shortest path route utilizing said another link cost.

31. The system of claim 28, wherein said programming to install further comprise programming to set a corresponding Management Information Base variable utilizing Simple Network Management Protocol.

32. The system of claim 28, wherein said information is collected by Remote Network Monitoring devices.

33. The system of claim 28, wherein said network is the internet.
